(19) United States
(12) Patent Application Publication
(10) Pub. No.: US 2007/0222771 A1
(43) Pub. Date: Sep. 27, 2007

(54) Proximity sensor display assembly and method

(76) Inventors: Kenneth Alan Brask, Lindenhurst, IL (US); Mark Antennora, Chicago, IL (US)

Correspondence Address: VEDDER PRICE KAUFMAN & KAMMHOLZ, 222 N. LASALLE STREET, CHICAGO, IL, 60601, US

(21) Appl. No.: 11/386,024

(22) Filed: Mar. 21, 2006

(51) Int. Cl. G09G 5/00

(52) U.S. Cl. 345/204

(57) ABSTRACT

This disclosure generally relates to a multimedia display equipped with a proximity sensor. The display is made of a device equipped with a proximity sensor and a computing device to better create and manage multimedia presentations. The display allows owners to insert a panel equipped with an LCD screen inside an enclosure with an opening in either a landscape or portrait orientation. Owners may use their computers to prepare, manage, and store audio and visual information. The display allows owners to better customize and use the device by using known computing, cabling, and display technology in conjunction with a robust enclosure. Finally, the display allows owners to rotate the LCD screen from a portrait orientation to a landscape orientation, or vice versa.

### FIELD OF THE DISCLOSURE

The present disclosure relates to an assembly and method for use of an electronic display, and more particularly, to an electronic display device equipped with a computing device and a proximity sensor to activate the device when needed to convey a visual message and possibly an auditory message to a recipient.

### BACKGROUND

Purveyors of services have long sought better ways to advertise and offer their services in a manner that increases their overall productivity. A key feature of the service industry is to convey selected information to a target audience under optimal circumstances. Use of multimedia presentations, such as the display of images in association with sound at the point of sale, has been shown to create a better overall impression, improving the quality of the service and optimize productivity. Museums add screens next to selected exhibits to create interactive archaeological and sociological stations and enhance an exhibit's overall experience. Retail stores allow suppliers to place televisions and DVD players next to products to increase sales. Corporations at retail shows appreciate the need for a multimedia display to draw potential clients to their booths to market their corporation, sell their new products, or advertise their latest services. Museums, retail stores, or even corporations benefit from improved multimedia displays. These are only examples of the myriad applications of a multimedia display. The usefulness of multimedia joint audio and video displays in the marketplace, as well as any other possible uses, is well known to one of ordinary skill in this art.

The technical requirements of a multimedia display device depend on the intended use of the display. Generally, most message conveying devices need to be durable, user friendly, robust, and affordable. The devices may also work without the help of a sales representative, and attract the attention of a user without contributing excessively to ambient auditory pollution. Often, a display device is left unattended on a stand or in a store. For this reason, the device must not be portable and must offer some level of theft protection. These devices must also be attractive enough to enhance the service experience while allowing flexibility in the creation and use of visual and possibly an audio message. The devices must ultimately capture the attention of an end user long enough to cause him/her to see and hear the entire message.

The needs of the purchasers and owners of multimedia display devices may differ from the needs of the ultimate consumer of the service. Owners need display devices that can be modified easily and that convey a wide range of audio and video messages in a plurality of formats, systems of exploitation, and transmission protocols. Owners also benefit from the acquisition of a display device that uses existing technology known to employees of the purchasing corporation and can be adapted to be displayed in different orientations.

Several devices already exist for conveying a message at a point of purchase of goods or services consisting of a video and possibly an audio display. One discloses a device where six pictures are arranged on a flat retro-lit panel shown over a tape-recorded narrative. Another discloses a point-of-purchase advertising system that utilizes an ultrasonic transducer to sense the presence of a person in the vicinity of the display and uses an endless tape playback unit for playing prerecorded advertisements on a speaker. Yet another discloses a display device equipped with an infrared sensor and an audio speaker that activates a retro-illuminated display made of two nonoverlapping transparencies.

More recently, devices have evolved to include digital displays such as flat screen monitors or plasma televisions. One discloses a blind, fixed audio and visual, waist-high terminal display station able to connect to the Internet and display different types of presentations. Another discloses an interactive advertising system where a user is able to retrieve information stored on a display device via a touch screen system. Neither is equipped with a proximity sensor to activate the device when the user is nearby or deactivate the device when the user is absent. Yet another discloses a public restroom system where an audio speaker and a video display screen are activated by a proximity sensor connected to a single control apparatus with limited audio and visual data processing capacity.

Although many of these devices are able to perform their intended functions in a workmanlike manner, none of them solve all of the drawbacks described above. What is needed is a display device that allows a display owner to broadcast to a user a variety of visual data and possibly complementary audio data from a computer to a user using a multi format screen, benefiting from simple and standardized connectors and cables technology, functionally grouping a proximity sensor technology along with the audio and video technology, offering owners the use of known hardware to reduce investment and limiting costs associated with maintenance, management, and display modifications.

### SUMMARY

This disclosure generally relates in one embodiment to a durable, user-friendly, and robust multimedia display assembly equipped with a proximity sensor and a method of use thereof. The display assembly in another embodiment may be made of a display device equipped with a proximity sensor that may be used in tandem with commonly used computing devices to better create and manage multi media presentations as seen and possibly heard by display viewers. The display device in another embodiment may also allow owners to insert a single panel equipped with the proximity sensor and possibly a speaker and a display surface such as a LCD screen or a plasma screen inside of an enclosure with an opening for the display surface in a landscape, a portrait orientation, or a other possible display orientation.

The disclosure may, in another embodiment, allow owners to use their computers to prepare, manage, and store audio and visual information to be broadcast, and to optimize services of the display assembly based on the information received from the proximity sensor located on the display device. The display assembly in another embodiment may also allow owners to better customize the use of the display device by using known computing, cabling, and display technology in conjunction with a robust enclosure and remote user detection technology. Finally, in another embodiment, the display assembly may allow owners of a single type of display to change from a portrait orientation to a landscape orientation, or vice versa, simply by changing the enclosure and rotating the display surface inside the display device.

### BRIEF DESCRIPTION OF THE DRAWINGS

FIG. 1 is a perspective view of the electronic display assembly.

FIG. 2 is an exploded perspective view of the electronic display device in the landscape orientation.

FIG. 3 is an exploded perspective view of the electronic display device in the portrait orientation.

FIG. 4 is a schematic diagram showing the interconnection of the components of the electronic display assembly.

FIG. 5 is a flow chart that schematically illustrates the steps of the method for providing display of visual data and possibly audible transmission of audio data.

FIG. 6 is a flow chart that schematically illustrates the steps of the further defined method for providing display of visual data and possibly audible transmission of audio data.

FIG. 7 illustrates a typical computer system in which part of the present invention operates.

FIG. 8 is a flow chart that schematically illustrates the steps of the method for changing a landscape oriented display assembly to a portrait oriented display assembly or vice versa.

### DETAILED DESCRIPTION

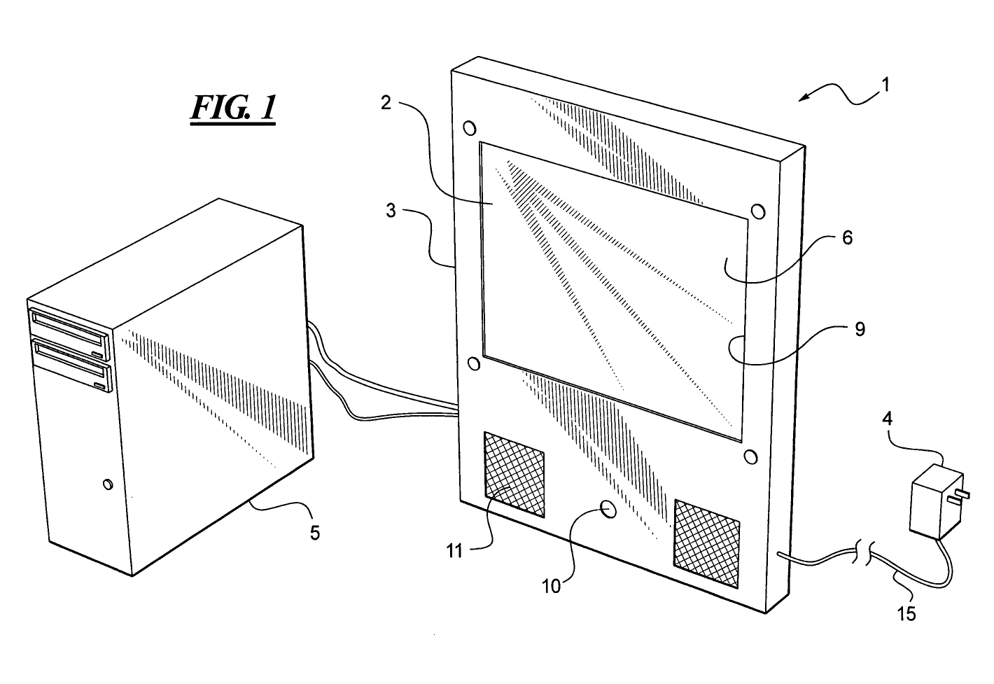

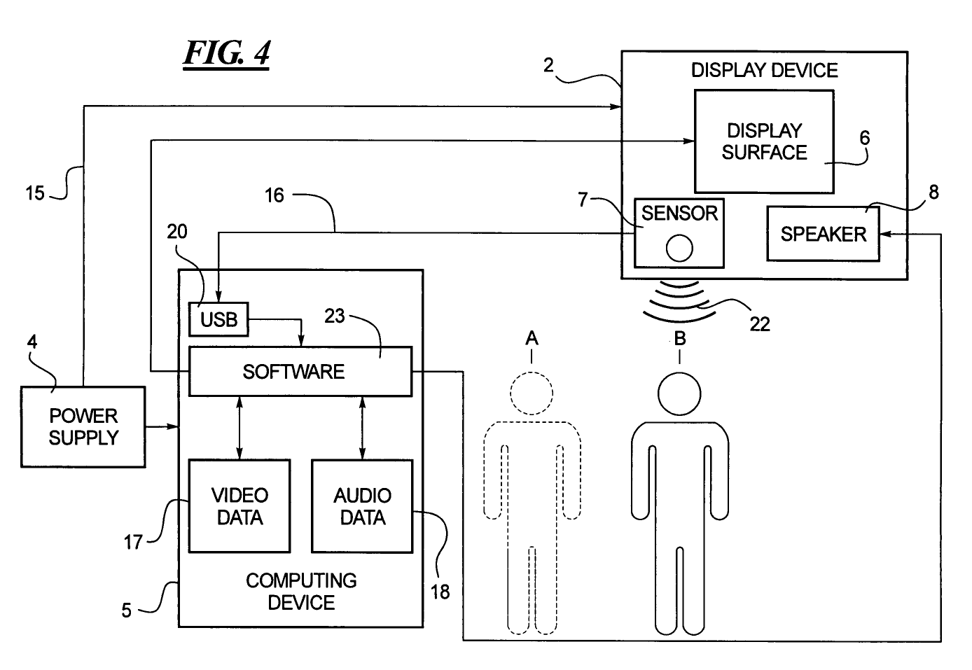

FIG. 1 shows a perspective view of the overall electronic display assembly 1. The electronic display assembly 1 is composed of five main elements: an electronic display device 2, an enclosure 3, a power supply 4, at least one speaker 8, and a computing device 5. In the preferred embodiment, the display assembly 1 comprises of at least one speaker 8, but it will be understood by one of ordinary skill in the art that the display assembly 1 can be operated without the at least one speaker or with the at least one speaker silent. The power supply as shown in FIG. 1 is an input socket connected to existing common outlets types. It is understood by a person of ordinary skill in the art that while a single power outlet for the supply of the electronic display assembly 1 is shown in FIG. 1, use of several other power input sockets or either alternative current (AC) or direct current (DC) for each of the main components or the use of a relay power supply within one of the main component is contemplated. In one preferred embodiment, a 12-volt DC current may be used to power the sensor 7 and the speaker 8. The power supply 4 is operatively coupled 15 to the display device 2 which is in turn coupled to all of the elements that need energy to operate properly, namely, at least one speaker 8, a proximity sensor 7, and the computing device 5 as shown on FIG. 4. Again, it is understood by one of ordinary skill in the art that all elements within the computing device 5, such as the system to operate software 23, access video data 17, the possible audio data 18, or the elements of the electronic display device 2 as associated to the computing device 5, such as the input and output USB port 20 or any other appropriate connector, are appropriately energized.

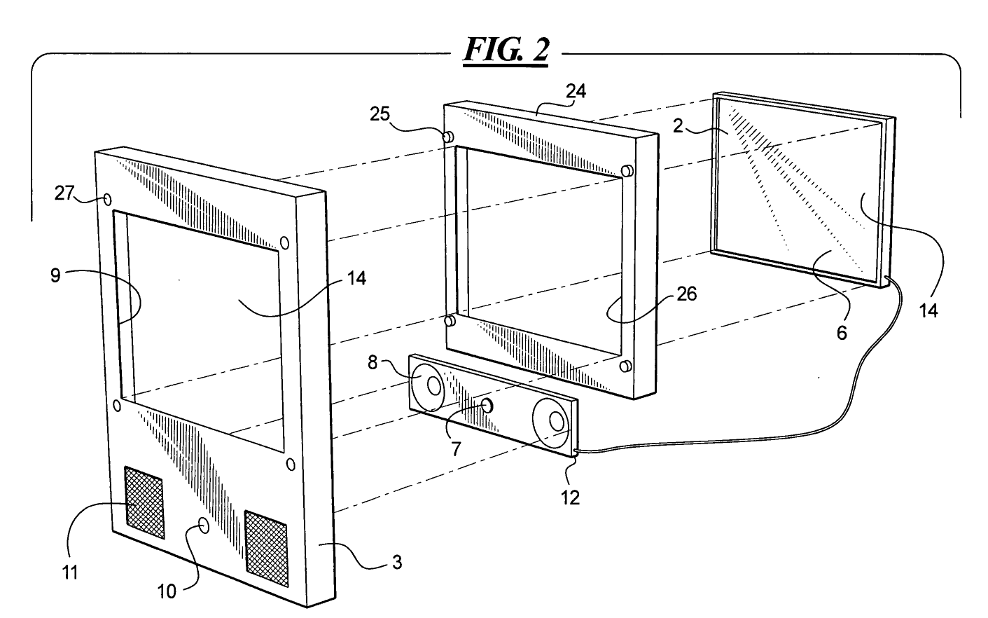

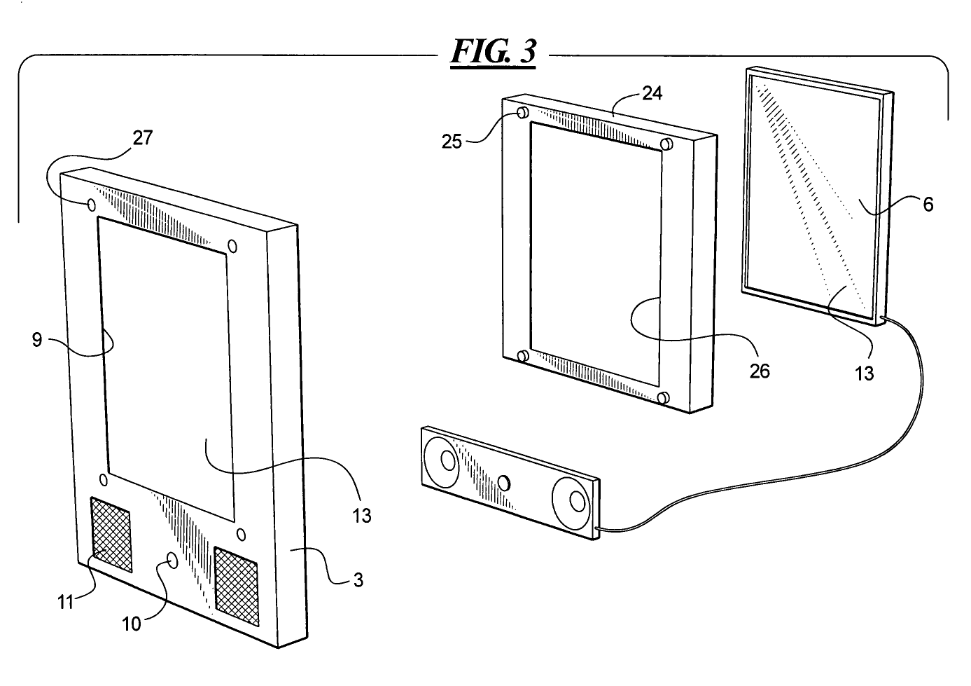

The electronic display device 2 is equipped with a display surface 6. In the preferred embodiment, the display surface 6 is oriented in either a landscape orientation 14 or a portrait orientation 13 as shown in FIGS. 2 and 3, respectively. It is understood by one of ordinary skill in the art that while the display surface width-over-height ratio shown and disclosed are those most commonly used in the industry, namely the ratios 4:3 or 16:9, any possible ratio is contemplated. While the use of a flat screen of either Liquid Crystal Display (LCD) or Plasma Display technology is disclosed as the current best mode, it is understood that other display technology standards such as Cathode Ray Tube (CRT), Digital Light Processing (DLP), Surface-conduction Electron-emitter Display (SED), Field Emission Display (FED), or any other new display technology may be used. A single display surface may be rotated and used in either a landscape orientation 14 or a portrait orientation 13 in two different enclosures, each designed for its specific type of display. It will also be understood by one of ordinary skill in the art that while rectangular 4:3 and 16:9 display surfaces are preferred in this art, other types of surface geometries of a display screen can be used based on user preferences and market availability such as the use of flexible screens and displays of irregular shapes.

Continuing with FIG. 2, the enclosure 3 is adapted to house the display surface 6, a proximity sensor 7, and possibly at least one speaker 8 both preferably mounted on a control panel 12. The enclosure 3 may be made of any material suitable to house the display surface 6 and the control panel 12, and may be equipped with any mounting or attachment means commonly used to permit a user to effectively position the enclosure at a display location. The enclosure is equipped with three effective openings, a first opening 9 to provide a view of the display surface 6 from outside the enclosure when the display surface 6 is mounted in the enclosure 3, a second opening 10 to provide access to the outside of the enclosure to the proximity sensor 7 when the proximity sensor 7 is mounted in the enclosure 3, and a third opening 11 sized to provide access to the outside of the enclosure to at least one speaker 8 when the speaker 8 is mounted to the enclosure. In an other embodiment where no speaker 8 is used, the enclosure will only be equipped with two openings. It is understood by one of ordinary skill in the design of enclosure openings that access is provided to a display surface 6 when light is allowed to pass through the enclosure allowing a user to perceive the display surface 6. Also, access is provided to a speaker 8 when sound waves are able pass the enclosure in the ambient medium, or that access is provided to a sensor 7 if the detection technology of the sensor is able to pass the enclosure. In the preferred embodiment, sensor 7 detects light waves at an infrared wavelength. The second opening 10 is either a physical opening or an effective opening in the enclosure material that allows infrared light waves to reach the sensor 7. Illustratively, the enclosure 3 is illustrated in FIGS. 1-3 as having a physical opening for all three openings. It is understood by one or ordinary skill in the art that, for example, if the enclosure were used in an underwater environment, the first opening may be transparent material, and the second opening would be made of a material able to allow the passage of sonar-type waves.

In one preferred embodiment, the infrared sensor 7 and two speakers 8 may be mounted on the control panel 12 in such a way as to allow the second opening of the enclosure 10 to be aligned with the sensor 7 and the third opening 11 to be aligned with the two speakers 8 when the control panel 12 is mounted. The control panel 12 is mounted within the enclosure 3 using any normal fixation means. The use of a single control panel 12 facilitates removal of the control panel 12 and the associated display surface 6 in order to place the panel and the display surface in a second enclosure 3 equipped with a different first opening 9 orientation.

In one preferred embodiment, the electronic display device 2 may further include a cover bezel 24 equipped with a series of corner openings 27 and a center opening 26 to provide access to the display surface 6. Corner openings 27 are made as in the enclosure 3 to allow the corner tabs 25 to be inserted in the associated corner tabs 25 on the cover bezel 24. This system allows a user who owns a single LCD screen or other display surface 6 to use his display surface 6 either in association with an enclosure 3 equipped with a first opening 9 in the portrait orientation 14 as illustrated in FIG. 2, or in association with an enclosure 3 equipped with a first opening 9 in the landscape orientation 13, as illustrated in FIG. 3 by rotating the display surface by ninety degrees and changing enclosure 3. It will also be understood by one of ordinary skill in the art that while the display assembly 1 is described using a rectangular display surface 6 with appropriately rectangular shaped enclosure openings, it will be apparent that a plurality of possible geometries used in association with a plurality of enclosures may be use at appropriate angle once rotated appropriately.

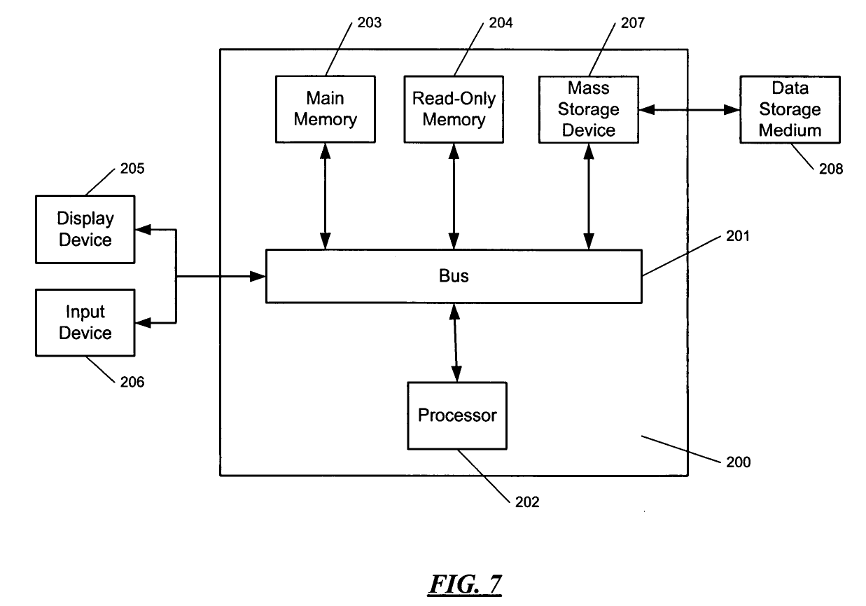

In FIG. 4, the sensor 7 is set to release an output 16 relayed to a computing device 5 via a connector 20. In the preferred embodiment, a Universal Serial Bus (USB) type connector is used, but the use of any type of connector 20 for a computing device 5 is contemplated. FIG. 4 illustrates a typical computing device 5 in which the video data storage 17 and possibly the audio data storage 18 operates, the preferred embodiment of which is implemented on a personal computer of IBM-type technology. In general, such computing devices generally shown in FIG. 4 as functionally illustrated in FIG. 7 comprise a bus 201 for communicating information, a processor 202 coupled with the bus 201 for processing information, main memory 203 coupled with the bus 201 for storing the information and instructions for the processor 202, a display device 205 coupled with the bus 201 for displaying information for a computer user, an input device 206 coupled with the bus 201 for communicating information and command selections to the processor 202, and a mass storage device 207, such as a magnetic disk or flash memory and associated disk drive, coupled with the bus 201 for storing information and instructions. A data storage medium 208 containing digital information is configured to operate with the mass storage device 207 to allow processor 202 to access to the digital information on data storage medium 208 via the bus 201.

In one preferred embodiment of the invention, the software 23 may be implemented in the computing device 5 in a conventional manner. Using well-known techniques, the video data 17 and the audio data 18 are stored in the data storage medium 208 and subsequently accessed by the software 23 as executed by the computing device 5. The information is processed and managed by the software 23 through the processor 202, and possibly the selected audio data 18 is sent to the speaker 8 while the video data 17 is sent to the display surface 6. The management of the video data and possible audio data to be processed is regulated by the software 23 in conjunction with the sensor output 16 received via the connector 20. The sensor output is calibrated to provide the software with proximity sensing data 22 converted from a trigger input set by the electronic display assembly 1 owner. In one of the preferred embodiments, a trigger detection of a configurable distance ranging from approximately 6 inches to approximately 15 feet is calibrated to relate to a certain proximity sensing data 22 level. It is understood by one of ordinary skill in the art that the sensor may be of a type to issue a signal output sensing data 22 as a voltage to be calibrated by the appropriate software 23, or the sensor is equipped with a cut-off trigger output to be set on the sensor and produces an all-or-nothing signal to the software 23.

Returning to FIG. 4, a user located at first position A may move moves closer to the sensor 7. A trigger sensor output 16 is set to trigger at a second position B and sends a signal through a cable to a connector 20. The computing device 5, with the use of the software 23, initiates the broadcast of a multimedia presentation to the user now located in position B. The software 23 retrieves video data 17 and possibly audio data 18 from the storage device 207 and sends the information to the display device 2 for display on the display surface 6 and possibly via the speaker 8. Once the user moves away from the position B, the trigger sensor output 16 changes, the computing device 5 changes or terminates the multimedia presentation. It is understood by one of ordinary skill in the art that the sensor output allows for the management of the video data 17 and possibly audio data 18 sent to the display device 2, including for example the termination or pause of the part of the multimedia presentation, a change in the parameters of the video and audio information such as lowering the level of the speaker output, changing the multimedia presentation to attract users from a more distant position, or any other possible and contemplated use of the electronic display device 2 by one of ordinary skill in the art.

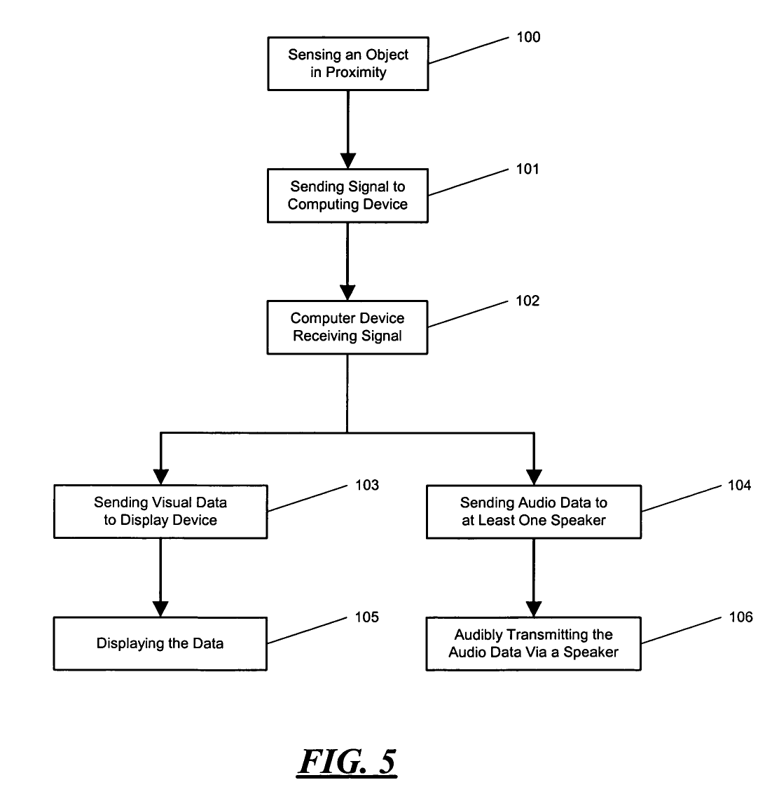

FIG. 5 contains a flow diagram illustrating the steps performed by an embodiment of the present invention for providing display and visual data and audible transmission of audio data. This method comprises a first step of sensing 100 an object or a user in the proximity of a display assembly 1 having an enclosure 3, the enclosure housing a display surface 6, at least one speaker 8, and a proximity sensor 7. The display assembly 1 may be installed at any location and in any fashion compatible with allowing a user to stand in front of the display assembly in such a way that allows the proximity sensor 7 to create a proximity sensing signal 22. The second step consists of sending 101 the proximity sensing signal 22 to a computing device 5 responsive to sensing the object in the proximity to the display device assembly 1. Third, the computing device 5 receives the proximity sensing signal 102, sends 103 visual data 17 to the display device 2 responsive to receiving of the proximity sensing signal 22, and sends 104 audio data 18 to at least one speaker 8 responsive to the receiving the proximity sensing signal 22. Finally, the visual data 17 and the audio data 18 are displayed 105 and audibly transmitted 106 to a user.

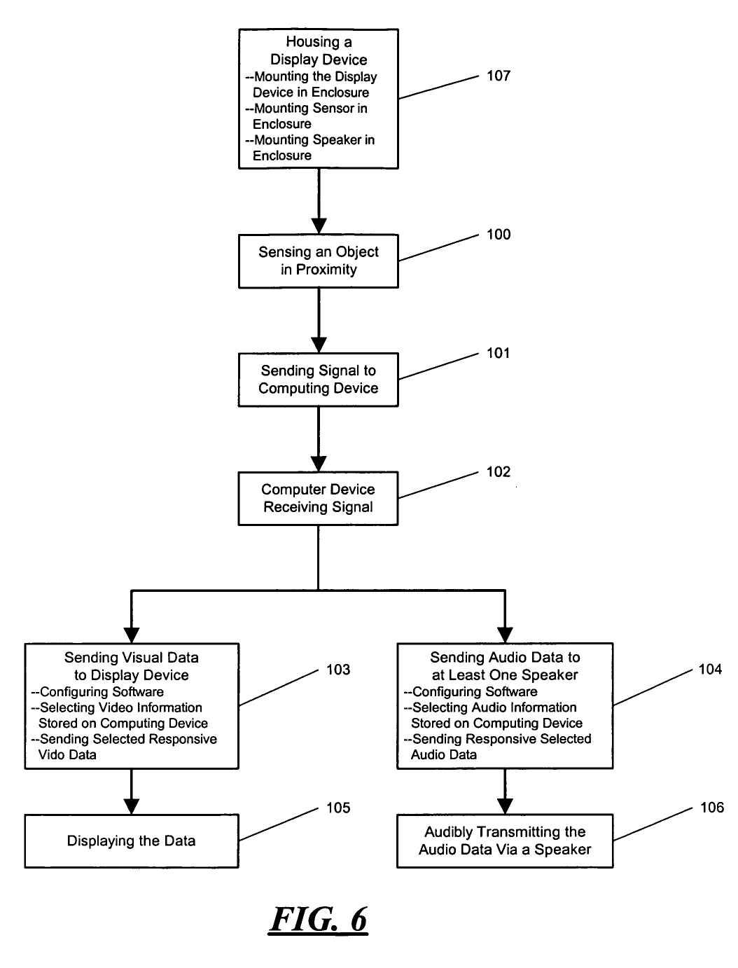

In a further embodiment, as illustrated in FIG. 6, the display device 2 serves as a housing 107, this step further comprises the steps of mounting the display device 2 in the enclosure 3 at a first opening 9 sized to provide a view of the display surface 6 of the display device 2 from the outside of the enclosure, mounting the proximity sensor 7 in the enclosure 3 at a second opening 10 sized to provide access to the outside of the enclosure to the proximity sensor 7, and mounting at least one speaker 8 to a third opening 11 sized to provide transmission of audio information 18 from the at least one speaker 8 to the outside of the enclosure.

The software may select the video information 17 to be sent to the display device 2 responsive to the computing device 5 receiving the proximity sensing signal 22 to be displayed 105. The software may also select the audio information 18 to be sent to the speaker 8 responsive to the computing device 5 receiving the proximity sensing signal 22 to be audibly transmitted 106.

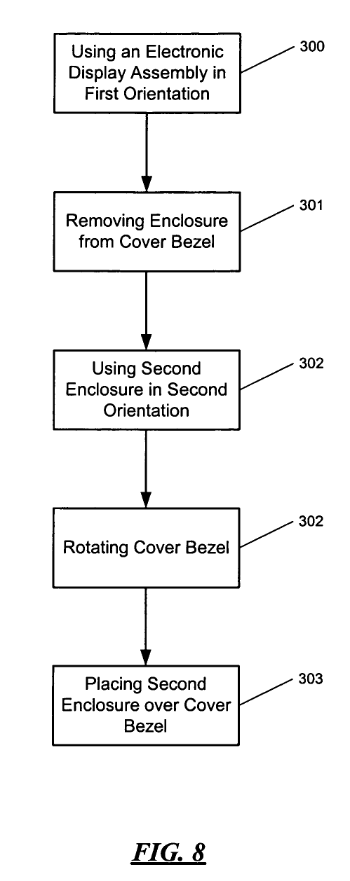

FIG. 8 illustrates a flow diagram showing the steps performed by an embodiment of the present invention for transforming a landscape oriented display assembly 14 as described herein into a portrait oriented assembly 13 or vice versa. This method allows a owner to transform his display assembly 1 from a first orientation to a second orientation by changing the enclosure 3 equipped with one type of opening with a second type of opening. The method comprises the steps of, using an electronic display assembly 300 comprising an enclosure, and a cover bezel each in the landscape orientation, the cover bezel including corner tabs inserted in a series of associated corner openings in the enclosure; removing the enclosure from the cover bezel 301; using a second enclosure adapted for the portrait orientation with a series of associated corner openings in the enclosure 302; rotating the cover bezel 303; and placing the second enclosure over the cover bezel by inserting the tabs of the cover bezel within the associated corner openings in the enclosure 304. It is understood by one of ordinary skill in this art that the location of the corner tabs 25 on the cover bezel 24, is based on the ratio and geometry of the display surface 6, the position of the corner tabs 25 and in turn mandates the location of the associated corner openings 27 on the enclosure 3. If an irregular shaped display surface 6 is used with an associated irregularly shaped cover bezel 24, then an associated plurality of possible enclosures may be designed each with corner openings placed according to the successive rotation of the irregular shaped display surface 6.

It is understood that the preceding is merely a detailed description of some examples and embodiments of the present invention and that numerous changes to the disclosed embodiments can be made in accordance with the disclosure herein without departing from the spirit or scope of the invention. The preceding description, therefore, is not meant to limit the scope of the invention but to provide sufficient disclosure to one of ordinary skill in the art to practice the invention without undue burden.

What is claimed is:

1. An electronic display assembly comprising:
an electronic display device having a display surface;
a proximity sensor having a sensor output;
an enclosure adapted to house the display surface, and the proximity sensor, the enclosure comprising: a first opening sized to provide a view of the display surface from outside the enclosure when the display surface is mounted in the enclosure; and a second opening sized to provide access to the outside of the enclosure to the proximity sensor when the proximity sensor is mounted in the enclosure; and
a power supply operatively coupled to the display device, and the proximity sensor to power the display device, and the proximity sensor.

2. The electronic display assembly of claim 1, wherein the electronic display assembly further comprises at least one speaker; wherein the power supply is operatively coupled to power the at least one speaker; and wherein the enclosure is further adapted to house the at least one speaker and provide access to the outside of the enclosure to the at least one speaker via a third opening.

3. The electronic display assembly of claim 1, further comprising a control panel, wherein the proximity sensor is mounted to the control panel, and wherein the control panel is mounted in the enclosure such that the second opening is aligned with the proximity sensor.

4. The electronic display assembly of claim 2, further comprising a control panel, wherein the proximity sensor and the at least one speaker are mounted to the control panel, and wherein the control panel is mounted in the enclosure such that the second opening is aligned with the proximity sensor and the third opening is aligned with the at least one speaker.

5. The electronic display assembly of claim 1, wherein the first opening of the enclosure is sized to provide a view of the display surface when the display device is mounted in the enclosure in a landscape orientation.

6. The electronic display assembly of claim 1, wherein the first opening of the enclosure is sized to provide a view of the display surface when the display device is mounted in the enclosure in a portrait orientation.

7. The electronic display assembly of claim 1, wherein the first opening of the enclosure is sized to provide a view of the display surface when the display device is mounted in the enclosure in a non portrait and a non landscape orientation.

8. The electronic display assembly of claim 1, wherein the sensor output is operatively coupled to a source of visual data, wherein the source provides the display device with visual data upon receiving proximity sensing information from the sensor output.

9. The electronic display assembly of claim 2, wherein the sensor output is operatively coupled to a source of visual data and audio data, wherein the source provides the display device with visual data and the at least one speaker with audio data upon receiving proximity sensing information from the sensor output.

10. The electronic display assembly of claim 9, wherein the source of visual data and the audio data is a computing device.

11. The electronic display assembly of claim 10, wherein the computing device includes a connector port adapted to receive the sensor output.

12. The electronic display assembly of claim 11, wherein the connector port is a universal serial bus (USB) port.

13. The electronic display assembly of claim 1, wherein the power supply is a DC power supply.

14. The electronic display assembly of claim 2, wherein the power supply is a DC power supply.

15. An electronic display system comprising:
a computing device having stored therein visual data, the computing device including a trigger input, and a visual data output;
an electronic display device having a video data storage operatively coupled to the visual data output;
a proximity sensor having a sensor output operatively coupled to the trigger input;
and a power supply operatively coupled to the display device, and the proximity sensor to power the display device, and the proximity sensor; wherein the display device receives visual data from the visual data storage upon the computing device receiving a proximity sensing data from the trigger input.

16. An electronic display system comprising:
a computing device having stored therein visual data and audio data, the computing device including a trigger input, a visual data output, and an audio data output;
an electronic display device having a video data storage operatively coupled to the visual data output;
at least one speaker having an audio data storage operatively couple to the audio data output;
a proximity sensor having a sensor output operatively couple to the trigger input; and
a power supply operatively couple to the display device, the at least one speaker, and the proximity sensor to power the display device, the at least one speaker, and the proximity sensor; wherein the display device receives visual data from the visual data storage and the at least one speaker receives audio data from the audio data storage upon the computing device receiving a proximity sensing data from the trigger input.

17. The electronic display system of claim 16, wherein the computing device comprises software stored therein, the software being configurable to provide selective visual data from the stored visual data and selective audio data from the stored audio data upon receiving the proximity sensing data from the trigger input.

18. The electronic display system of claim 15, wherein the computing device comprises software stored therein, the software being configurable to provide selective visual data from the stored visual data upon receiving the proximity sensing data from the trigger input.

19. The electronic display system, of claim 16, further comprising an enclosure adapted to house the display device, the proximity sensor, and the at least one speaker, the enclosure comprising:
a first opening sized to provide a view of the display surface from outside the enclosure when the display device is mounted in the enclosure;
a second opening sized to provide access to the outside of the enclosure to the proximity sensor when the proximity sensor is mounted in the enclosure; and
a third opening sized to provide access to the at least one speaker to the outside of the enclosure when the at least one speaker is mounted in the enclosure.

20. The electronic display system, of claim 15, further comprising an enclosure adapted to house the display device, and the proximity sensor, the enclosure comprising:
a first opening sized to provide a view of the display surface from outside the enclosure when the display device is mounted in the enclosure; and
a second opening sized to provide access to the outside of the enclosure to the proximity sensor when the proximity sensor is mounted in the enclosure.

21. The electronic display assembly of claim 15, wherein the trigger input is set to engage if motion is detected within a configurable distance ranging from approximately 6 inches to approximately 15 feet of the proximity sensor.

22. The electronic display assembly of claim 16, wherein the trigger input is set to engage if motion is detected within a configurable distance ranging from approximately 6 inches to approximately 15 feet of the proximity sensor.

23. The electronic display assembly of claim 15, wherein the power supply is a DC power supply.

24. The electronic display assembly of claim 19, wherein the electronic display device further includes a cover bezel equipped with a series of corner tabs and a center opening, the center opening sized to provide access to the display surface, and the enclosure further comprising a series of corner openings arranged to allow the corner tabs to be inserted in the associated corner openings in order to mount the cover bezel to the enclosure.

25. The electronic display assembly of claim 24, wherein the first opening of the enclosure is sized to provide a view of the display surface when the cover bezel is mounted in the enclosure in a landscape orientation.

26. The electronic display assembly of claim 24, wherein the first opening of the enclosure is sized to provide a view of the display surface when the cover bezel is mounted in the enclosure in a portrait orientation.

27. The electronic display assembly of claim 24, wherein the first opening of the enclosure is sized to provide a view of the display surface when the cover bezel is mounted in the enclosure in a non portrait and a non landscape orientation.

28. A method of providing display of visual data and audible transmission of audio data comprising the steps of:
sensing an object in proximity of a display assembly using a proximity sensor, the display assembly having an enclosure, the enclosure housing a display device, at least one speaker, and the proximity sensor;
sending a proximity sensing signal to a computing device responsive to sensing the object in proximity of the display device assembly, the computing device receiving the proximity sensing signal;
sending visual data from the computing device to the display device responsive to the computing device receiving the proximity sensing signal;
sending audio data from the computing device to the at least one speaker responsive to the computing device receiving the proximity sensing signal; and
displaying the visual data with the display device and audibly transmitting the audio data with the at least one speaker.

29. The method of providing display of visual data and audible transmission of audio data of claim 27, further comprising the steps of: housing the display device, the proximity sensor, and the at least one speaker in an enclosure, the step of housing the display device comprising: mounting the display device in the enclosure at a first opening of the enclosure, the first opening sized to provide a view of a display surface of the display device from outside the enclosure; mounting the proximity sensor in the enclosure at a second opening sized to provide access to the outside of the enclosure to the proximity sensor; and mounting the at least one speaker at a third opening sized to provide transmission of audio information from the at least one speaker to the outside of the enclosure.

30. The method of claim 28, wherein the first opening is sized for mounting of the display device in a landscape orientation.

31. The method of claim 28, wherein the first opening is sized for mounting of the display device in a portrait orientation.

32. The method of claim 28, the sending of video information to the display device comprising configuring a software stored on the computing device to send a selected video information stored on the computer, wherein the software selects the selected video information for sending to the display device responsive to the computing device receiving the proximity sensing signal.

33. The method of claim 28, the sending of audio information to the display device comprising configuring a software stored on the computing device to send a selected audio information stored on the computer, wherein the software selects the selected audio information for sending to the at least one speaker responsive to the computing device receiving the proximity sensing signal.

34. The method of claim 28, further comprising powering the display device, the proximity sensor, and the at least one speaker with a power supply.

35. The method of claim 28, wherein the power supply is a DC power supply.

36. A method of transforming a landscape oriented display assembly into a portrait oriented assembly or vice versa, the method comprising the steps of:
using an electronic display assembly comprising an enclosure, and a cover bezel each in the landscape orientation, the cover bezel including corner tabs inserted in a series of associated corner openings in the enclosure;
removing the enclosure from the cover bezel;
using a second enclosure adapted for the portrait orientation with a series of associated corner openings in the enclosure;
rotating by ninety degrees the cover bezel; placing the second enclosure over the cover bezel by inserting the tabs of the cover bezel within the associated corner openings in the enclosure.
